(19) United States
(12) Patent Application Publication
(10) Pub. No.: US 2002/0178117 A1
(43) Pub. Date: Nov. 28, 2002

(54) Electronic bill presentment system with automated tax and fee adjustment

(75) Inventors: Kellie Jo Maguire, South Berwick, ME (US); Gregory Park, Stratham, NH (US)

Correspondence Address: TIMOTHY P. O'HAGAN, P.O. BOX 1054, PORTSMOUTH, NH, 03802, US

(73) Assignee: Bottomline Technologies (DE) Inc., Portsmouth, NH

(21) Appl. No.: 10/053,193

(22) Filed: Jan. 16, 2002

Related U.S. Application Data
(63) Continuation-in-part of application No. 09/825,231, filed on Apr. 3, 2001.

(51) Int. Cl. G06F 17/60

(52) U.S. Cl. 705/40

(57) ABSTRACT

An electronic bill presentment and payment system for presenting an invoice of a vendor to a customer comprises a billing database for storing an invoice file. The invoice file comprises a line value representing an amount payable by the customer for a product provided by the vendor, a tax value representing an amount payable as a tax on the product, and a fee value representing an amount payable as a fee on the product. An application server provides for receiving a request to adjust the line value from the customer, providing instructions to replace the line value with an adjusted line value, calculating an adjusted tax value and an adjusted fee value based on the adjusted line value, and providing instructions to replace the tax value with the adjusted tax value. Where appropriate, flat fee adjustments are also made.

### TECHNICAL FIELD

The present invention relates to a financial transaction system and method, and more particularly, to an improvement for a network-based system and method for adjustments in billing and payment.

### BACKGROUND OF THE INVENTION

Historically, a purchaser of goods or services orders them from a vendor, to whom the customer agrees to pay a specified price. The vendor then provides the customer the goods ordered, along with an invoice. The amount invoiced should equal the amount which the customer agreed to pay. To ensure this, invoice presentment and bill payment procedures have always involved a few steps. First, the vendor delivers (or present) an invoice to a customer. Thereafter, the customer reviews the invoice, to make sure, for example, that the goods and services listed on the invoice were those actually delivered or performed, that the charges for each were correct, and that any taxes, fees, or additional surcharges based on the same had been computed correctly and added correctly into the total amount due. If everything was in order, the customer would typically send a check to the vendor. In most cases, invoice payment was a perfunctory act—and quite suitable for automation Indeed, some time ago, first generation electronic bill-payment systems which fully automated this process, in its simple case.

However, if, upon reviewing the invoice, the customer noticed an error, he would notify the vendor that the invoice needed “adjustment”. Negotiations would be held between personal representatives of the vendor and personal representatives of the customer, resulting in the customer and vendor agreeing to an “adjustment” and each appropriately making appropriate adjustments in their respective business's accounting systems.

To solve this lingering problem, second-generation invoice presentation and payment systems were developed which may also automate, not only the presentation and payment of fixed invoices, but also automate the disputation of invoice data such as quantity, unit cost, total price, etc, and, where appropriate, automate the adjustment of such invoice datum or data. Automatic adjustment works as follows: upon examining a bill or invoice, a customer may propose invoice adjustments on-line to the invoice presentation system. If the character or type of the adjustment(s) are ones which were agreed to (that is, to be allowable) in advance by the vendor and customer, then the invoice presentation system may automatically make the adjustment, and ideally, complete the transaction. Ordinarily, at that time the invoice presentation system would notify the vendor that an adjustment had been made, for reasons including the prevention of fraud and facilitating the reconciliation of accounting records.

Unfortunately, even with the addition of automated adjustments to the automated payment process, closing even an automatically paid and automatically adjusted transaction would still often require manual intervention. This is because the adjustment of the quantity or price of the goods or services invoiced will typically also require adjustment of numerous ancillary fees or charges which are incidental to the transaction and which often have a complex dependence on the quantity or price of the goods or services invoiced. Two common examples of such ancillary items are taxes, which are often dependent on sales price, and delivery charges, which depend on quantity delivered. Another common example of an ancillary item is a so-called “flat fee”, discussed in further detail elsewhere herein. (Unless otherwise specified, as used herein the term “tax” denotes an amount which is the product of a percentage and a dollar baseline value; the term “fee” denotes an amount which is the product of a dollar baseline amount and a number of units (being vended); the term “flat fee” is an arbitrary amount having one of three values: (−1.0, 0.0, or +1.0). It is readily seen that if a system accepts an adjustment to a base line item of an invoice, the invoice must be further adjusted to reflect the change in the amount of the ancillary item, which usually will need to be changed due to the line item adjustment. Only then can the transaction be considered closed. No known currently available systems perform this step efficiently, if at all.

While, for purposes of brevity, examples given herein are largely concerned with ancillary items which have a value which is are directly dependent upon a base line item value, it will be apparent to those of ordinary skill in the relevant arts that the present invention of course extends to cases in which the value of an ancillary item (referred to as the “child”) is indirectly dependent upon a base line item value, in that it depends directly upon another ancillary item (referred to as the “parent”) which itself depends directly upon a base line item value. In such a case, of course, an adjustment to the base line item value will cause adjustments in the “parent” and “child” ancillary items, while the adjustment of a “parent” ancillary item may cause an adjustment only in the “child” ancillary item, not in the base line item value upon which the parent depends. Similarly, it will be apparent to those of ordinary skill in the relevant arts that there may be any number of a plurality of “generations” which may be handled by the present invention; accordingly, and again in the interests of brevity, these “multi-generational” dependencies are not depicted herein, it being understood that the current disclosure, particularly with the instant paragraph, adequately discloses how the present invention handles “multi-generational” dependencies.

And so, for transactions which would otherwise be automated, due to ordinary and even adjusted payments having been automated, closing a transaction would still require personal representatives of the vendor and personal representatives of the customer(s) to expend considerable time and effort to perform the recalculation (and adjustment) of ancillary items taxes, fees, and charges necessitated by adjusting the base line item(s) on an invoice. It should be appreciated that the (re)calculation of these ancillary items is often quite complex, particularly for a transaction involving the provision of a highly regulated and taxed substance, such as aviation fuel, where the calculations necessary to adjust these ancillary items are often quite complex, involving, for example, sliding tax scales, or on taxes that vary due to geography and multiple jurisdictions, and transaction-specific delivery fees and charges.

As such, there is a need for an invoice presentment system that does not suffer the disadvantages discussed above, and in fact overcomes them, by fully automating the invoice presentment and payment process, including having means for performing the automatic adjustment of ancillary line items (e.g. taxes and/or fees) made necessary by an automatic adjustment of invoice base line items, so that a transaction may be closed in fully automated fashion.

### SUMMARY OF THE INVENTION

The present invention is to provide an automatic electronic bill presentment and payment system with added functionality including automatic adjustment of an invoice made when an invoice presented for payment has a disputed value in its base line item (e.g. quantity or unit price) (sometimes referred to herein as line value) and further including automatic adjustment of the invoice's ancillary line items (e.g. taxes and/or fees) (sometimes referred to herein as tax value or fee value (respectively)) such as may be made necessary by the adjustment of the invoice due to the adjustment of the base line items, or which (in the case of flat fees) may be made necessary by the direct adjustment of the flat fee itself.) In a first embodiment, the biller system (and the payer system) may be configured with a manual user interface which enables a human user to both enter and obtain data and which is configured to exchange data with the electronic bill presentation and payment processing system using HTML. In a second embodiment, the biller system (and the payer system) may be configured to exchange transactions directly with the biller accounting system (or the payer accounting system) using a transaction definition compatible with such system and configured to exchange data with the electronic bill presentation and payment processing system using XML.

### BRIEF DESCRIPTION OF THE DRAWING

FIG. 1 is a block diagram of an electronic bill presentment and payment system, and associated systems, consistent with the present invention;

FIG. 2a is a diagram illustrating exemplary operation of a client workstation operated manually, and using HTML tagged data elements, in accordance with one embodiment of the invention;

FIG. 2b is a diagram illustrating exemplary operation of the Accounting Systems Interface Application (ASIA), facilitating automatic operation and using XML tagged data elements in accordance with one embodiment of the invention;

FIG. 3 is a diagram illustrating the operation of a plurality of IBSPs and a plurality of EBPPs and other service systems in accordance with another embodiment of the invention;

FIG. 4 is a chart listing, in each row thereof, a calculated values and the calculation formula used to obtain that value;

FIG. 5 is a chart listing, in each row thereof, a database entity, an initializing value associated with that database entity, and an example value of that database entry;

FIG. 6 is an illustration of tax and service fee calculation data used in connection with the current invention;

FIG. 7 is a state diagram illustrating examination of invoice, examination of invoice (detailed) and adjustment of invoice, all in accordance with the present invention;

FIG. 8 is a workflow diagram illustrating the automatic adjustment of an invoice, in accordance with the present invention;

FIG. 9 is a sample invoice for the sale of Aviation Fuel, which bears an error which will require its adjustment utilizing the method and system of the present invention;

FIG. 10 is a sample invoice for the sale of Aviation Fuel which was given in FIG. 9, adjusted utilizing the method and system of the present invention;

FIG. 11 depicts a sample invoice for the sale of Aviation Fuel;

FIG. 12 depicts the invoice of FIG. 11, with Line Item Units adjusted;

FIG. 13 depicts the invoice of FIG. 12, with adjustment made to the alternate basis number;

FIG. 14 depicts the invoice of FIG. 12, with Parent Federal Excise and LUST tax adjusted;

FIG. 15 depicts the invoice of FIG. 14, with Child Exempt FL State Sales tax adjusted;

FIG. 16 depicts an invoice illustrating certain aspects of flat fees.

### DETAILED DESCRIPTION

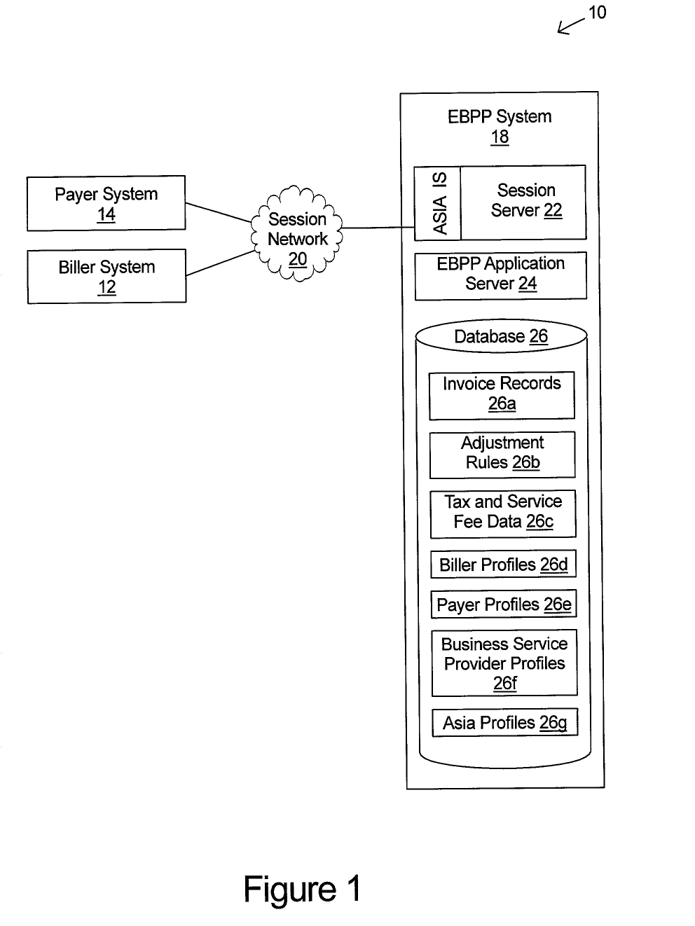

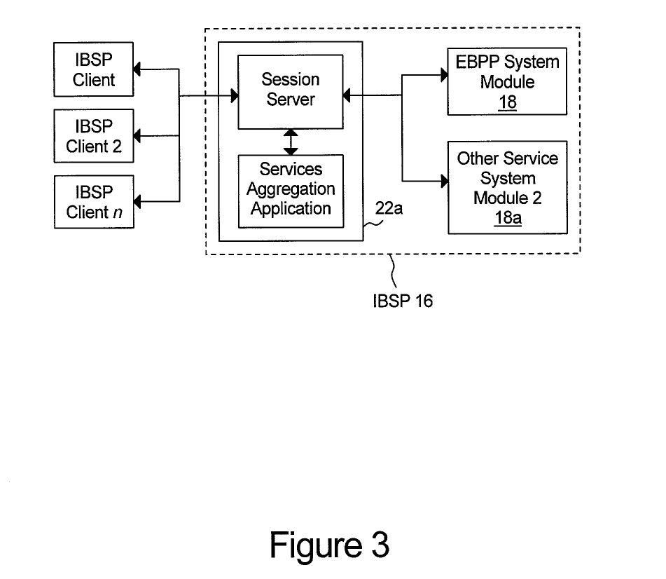

FIG. 1 illustrates an ELECTRONIC BILL PRESENTMENT AND PAYMENT SYSTEM 10 (EBPPS) of the present invention. EBPPS 10 may comprise at least one BILLER SYSTEM 12, at least one PAYER SYSTEM 14, and an ELECTRONIC BILL PRESENTMENT AND PAYMENT MODULE (EBPPM) 18, all in communication with one another via a SESSION NETWORK 20, which may comprise Internet or private networking. It should be appreciated that BILLER SYSTEM 12 and PAYER SYSTEM 14 are most typically operating as or on computers or “workstations” remotely located from each other and from EBPPS 18 and that they may be controlled by separate entities. Alternatively, they may, in whole or in part, be commonly controlled and/or located at a single entity. Note further that EBPPS 18 may be part of a larger system, called an INTEGRATED BUSINESS SERVICES PROVIDER (IBSP) 16. Indeed the IBSP 16 may comprise one or more of a plurality of (service) System Modules, as shown, for example, in FIG. 3.

EBPPS 18 comprises the following subsystems: SESSION SERVER 22, which connects the EBPPM 18 to other systems via SESSION NETWORK 20; the EBPP DATABASE 26, and the EBPP APPLICATION SERVER 24. EBPP DATABASE 26 has storage which comprises all the data necessary to the function of the EBPP SYSTEM 18, including but not limited to INVOICE RECORDS 26a, ADJUSTMENT RULES 26b, TAX & SERVICE FEE DATA 26c, BILLER PROFILES 26d, PAYER PROFILES 26e, BUSINESS SERVICE PROVIDER PROFILES 26f, and ASIA PROFILES 26g. SESSION SERVER 22 may itself comprise an ACCOUNTING SYSTEMS INTERFACE APPLICATION (ASIA) 15. Regarding ASIA: ACCOUNTING SYSTEM INTERFACE APPLICATION (ASIA): ASIA 15 may comprise a “translation engine” which translates data from whatever format is “native” to BILLER SYSTEM 12 or PAYER SYSTEM 14 into a format used by EBPP SYSTEM 18, e.g. into a “Bottomline 810 file”, which is a customized ANSI 810 file used in certain applications available from Bottomline Technologies, Inc., of Portsmouth, N.H. It should be readily understood that ASIA 15, and, when appropriate, associated ASIA 15 databases 26g, may be present/running on SESSION SERVER 22.

EBPP APPLICATION SERVER 24 may comprise means for receiving a request to adjust an invoice line item value from the customer, and means for providing instructions to replace the line item value with an adjusted line item value, and means for calculating an adjusted tax value based on the adjusted line item value, and means for providing instructions to replace the unadjusted ancillary item value with the adjusted ancillary item value.

Note that one or more of BILLER SYSTEM 12, PAYER SYSTEM 14, and INTEGRATED BUSINESS SERVICES PROVIDER (IBSP) 16 each comprise computing devices with appropriate hardware and software for interfacing with IBSP 18, and that they may, via SESSION NETWORK 20, interface with EBPP MODULE 18. The BILLER SYSTEM 12 and PAYER SYSTEM 14 may comprise computing devices with appropriate hardware and software for interfacing with EBPP 18.

Recall that one of the fundamental operations of EBPP SYSTEM 10 is to enable the automatic payment of bills. Generally speaking, this is accomplished after billing data (e.g. invoices) have been transmitted from BILLER SYSTEM 12 via SESSION NEWORK 20 to EBPP MODULE 18, and has been stored in EBPP DATABASE 26. Once one or more invoices has been so stored, PAYER SYSTEM 14 may, via SESSION NETWORK 20, connect with EBPP MODULE 18, and effectuate the payment of invoices in a manner discussed in further detail elsewhere herein.

One important aspect of the system of the present invention is that it may operate in one of two ways, i.e. (1) “manually”, e.g. by an human operator manually, e.g. by manual data entry into browsers running on a Payer System 14 workstation or an a Biller System 12 workstation, with data to be passed from the browsers to EBPPM 18 to as hypertext markup language (HTML) code, or (2) “automatically”, as by automatic data transfers, as extensible markup language (XML) code, between EBPPM 18 between PAYER SYSTEM 14, BILLER SYSTEM 12, and/or ASIA 15.

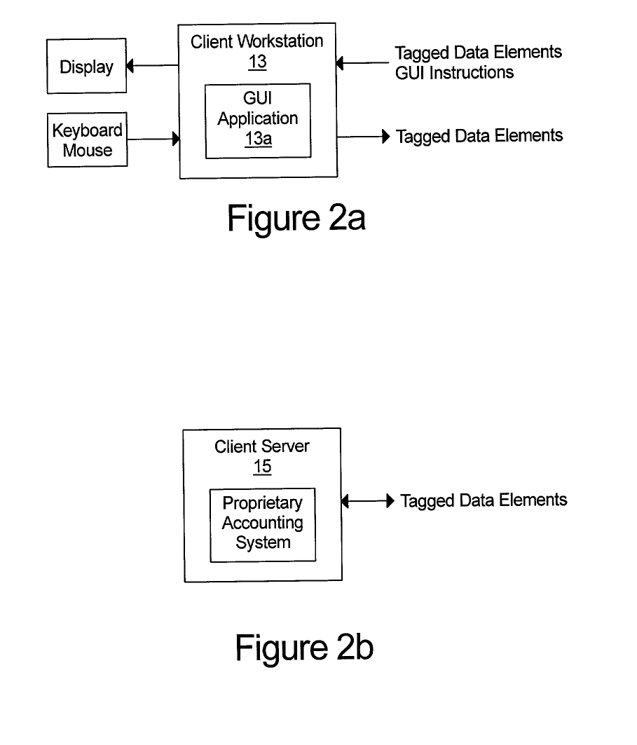

A diagram illustrating manual operation is given in FIG. 2a, which illustrates a client workstation 13, running a GUI application 13a, e.g. a browser application such as are well known to those skilled in the relevant arts. Note that the Client Workstation, as is well-known to those skilled in the relevant arts, comprises a Keyboard and Mouse for facilitating data entry, and a Display for displaying information.

A diagram illustrating automatic operation is given in FIG. 2b, which may be understood with respect to BILLER SYSTEM 12 and/or a PAYER SYSTEM 14, which eliminates the need of the BILLER USER of BILLER SYSTEM 12 or a PAYER SYSTEM USER of PAYER SYSTEM 14 to manually enter data input to (or output from) the appropriate system, and to transfer that data, e.g. by HTML. More specifically, XML messages conveying that data may be used to automatically convey that data in or out of EBPPS 18, as through ASIA 15. Those of ordinary skill in the art will recognize that such data may be generated by one of any number of commercially available proprietary accounting and/or billing systems, e.g., SAP, Oracle Financials, J D Edwards, People Soft, Great Plains, etc. The data outputted by these billing systems and input into the EBPPS 18 through ASIA 15 may come in a variety of formats including raw data, print file format, and X-12 ANSI 810 (EDI) (and its predecessor or successor standards, as well as comparable standards). In another alternative embodiment of the present invention, the INTEGRATED BUSINESS SERVICES PROVIDER (IBSP) 16 may be a so-called “exchange box” or other service bureau application(s) providing a plurality of business data processing services, one of which is EBPP 18, in accordance with the present invention.

Reference is now made to FIG. 3, in which the dotted line encloses the INTEGRATED BUSINESS SERVICES PROVIDER SYSTEM (IBSPs) 16 which is seen to comprise not only EBPP 18 but also other System Service Module(s) 18A as may be appropriate and desired. (For brevity, only one module 18a is shown, it being understood that there may be any number of modules, each performing its own function as may be desired.)

Note that, alternatively, some or all of the adjustment rules, rather than being stored in a database such as ADJUSTMENT RULES DATABASE 26b, could be hard-coded into the application 24; however the presently preferred embodiment has said adjustment rule present in ADJUSTMENT RULES DATABASE 26b.

Acceptable data formats may be, for example, of the formats such ANSI X12 810, flat ASCII files, etc., as well as of well formed XML schemas. There are also industry-specific standards. In the area of purchasing aviation fuel, for example, the American Petroleum Institute (www.api.org) has codified standard formats for invoices and has (at the time of filing the present patent) published these standards as “Publ 3800, AVNET—Electronic Document Formats for Aviation Fuel Sales.” According to the American Petroleum Institute, this “ . . . includes instructions for implementing electronic formats for aviation fuel invoices, delivery tickets, price notifications, and electronic payment/remittance advice transactions sets. Conventions for the use of these documents encompass both the American National Standards Institute (ANSI) ASC X12 EDI format and the United Nations EDIFACT (UN/EDIFACT) standard.”

According to the presently preferred embodiment, a one or more databases/servers used herewith may be an OLTP (on-line transaction processing) system, embodied in a server, such as Microsoft Structured-Query Language (SQL) Server 7™ or another OpenDatabase Connectivity (ODBC)—compliant database. EBPP DATABASE 26 may well be a “relational database”, the theory and operation of which are well-known to those of ordinary skill in the relevant art.

The contents of the various databases are as follows: INVOICE RECORDS 26a comprise sets of data fields specific to each invoice, and may, in a presently preferred embodiment, comprise data as specified in “American Petroleum Institute 3800, AVNET—Electronic Document Formats for Aviation Fuel Sales”, the entire contents of which are hereby incorporated by reference' and which are available through the website at www.api.org. ADJUSTMENT (DISPUTE) RULES 26b contains the rules governing adjustments (disputes); note that some of these rules may be payer-specific (i.e. making the governing rules different for different customers) or may be applied globally to all payers. These rules most typically define allowable adjustments in qualitative fashion, e.g. by stating, for example, the fields that are adjustable. TAX AND OTHER ANCILLARY ITEM DATA 26c may comprise data such as tax tables and delivery fee schedules, etc. PAYMENT RECORDS 26d comprises records relating to data such as payments made, the current state of a payment, and the status history of the payment (which may track any changes made to a payment record, as well as the identity of who made the changes. BILLER PROFILES 26d and PAYER PROFILES 26e respectively contain biller-specific and payer specific data, e.g. name, address, identity of the party or parties responsible for billing or payment, etc.; e.g., data which one of ordinary skill in the relevant arts might commonly expect to find on the header of an invoice or payment transfer. BUSINESS SERVICE PROVIDER PROFILES 26f contain similar profile data for one or more third-party IBSPs 16, and ASIA PROFILES 26g (which, additionally, or alternatively, may be present in SESSION SERVER 22) contains data relevant to each third-party accounting system (not shown for clarity and brevity) with which EBPP SYSTEM 10 might be operated with.

Biller System Operation

Operation of the BILLER SYSTEM 12 may be better understood with reference to the figures, as well as to the specification and all appended claims.

Before the first use of the EBPP SYSTEM 10, the user of BILLER SYSTEM 12 will create a BILLER PROFILE which will be stored at BILLER PROFILES DATABASE 26d. BILLER PROFILE DATA (which the system may be adapted to store as global information on the database) will comprise information such as the following: name, address, city, state, zip, country, SIC code, TIN, and default template type.

The user of BILLING SYSTEM 12 enters into a workstation the specifics of each and every individual invoice which is intended for payment by a particular payer. Note: those skilled in the relevant arts will notice that operation, for example purposes, is discussed with reference to manual operation, it is readily understood that automatic operation would proceed in very similar fashion) These invoice specifics include all necessary accounting information corresponding to the commercial transaction which the invoice covers; this information is known to those skilled in the relevant arts and may include invoice-specific data received from the BILLER SYSTEM 12. Every invoice entered into BILLER SYSTEM 12 is transmitted to EBPPM 18 though SESSION NETWORK 20; in the presently preferred embodiment of the invention this transmission occurs field by field. Invoice data is stored on INVOICE RECORDS 26a and will include all data from the invoice, including but not limited to all line items, unit prices, quantities, purchase orders, dates of order, dates of delivery, purchase order numbers, etc. Invoice data will be stored there while it waits to be accessed by the payer, as will be explained further herein.

However, in accordance with a feature of the present invention, the biller may monitor the “progress” of each invoice as it makes its way through each “gatekeeper” in the payer's invoice review and approval process. This is because the system not only provides simple invoice presentment, but also automates routing the invoice through a customer's multi-level (invoice) approval process, while providing certain status information to the vendor to assist the vendor in its cash management. Status information is provided to the vendors (billers) through the web interface, and may use emails for certain important status events and some reporting. After approval by the first gatekeeper person, the system will notify the second gatekeeper person. The system will one after another, notify every gatekeeper person (examples of which are given later herein) in the invoice-approval process that an on-line invoice requires their approval. The pattern continues until the process is complete and the customer schedules invoice payment to be made on a specified date. Notably, an advantage of the presently preferred embodiment is that the biller may, through requests made to EBPP module 18, track invoice payment status from the time of presentment right through the time of payment.

Payer System Operation

Operation of the PAYER SYSTEM 14 may be better understood with reference to the figures, as well as to the specification and all appended claims.

Before the first use of the EBPP SYSTEM 10, the user of PAYER SYSTEM 14 will create a PAYER PROFILE which will be stored at PAYER PROFILES DATABASE 26e. PAYER PROFILE DATA (which the system may be adapted to store as global information on the database) will comprise information such as the following: name, address, city, state, zip, country, SIC code, TIN, and default template type.

Each PAYER SYSTEM 14 user logs in to the PAYER SYSTEM 14, which may display a biller list, which may include all billers that the payer has a relationship with in the EBPP system 10. The EBPP system 10 may permit the PAYER SYSTEM user to click on any biller to get a list of invoices from that biller.

The user of the PAYER SYSTEM 14 (which may, as explained elsewhere, be either human or computer, will select selects invoices which he (or it) wishes to pay. The EBPPM 18 will, via the software running an EBPP APPLICATION SERVER 24, generate and provide to the PAYER SYSTEM 14 user an invoice list page displaying invoices which meet the selection criteria.

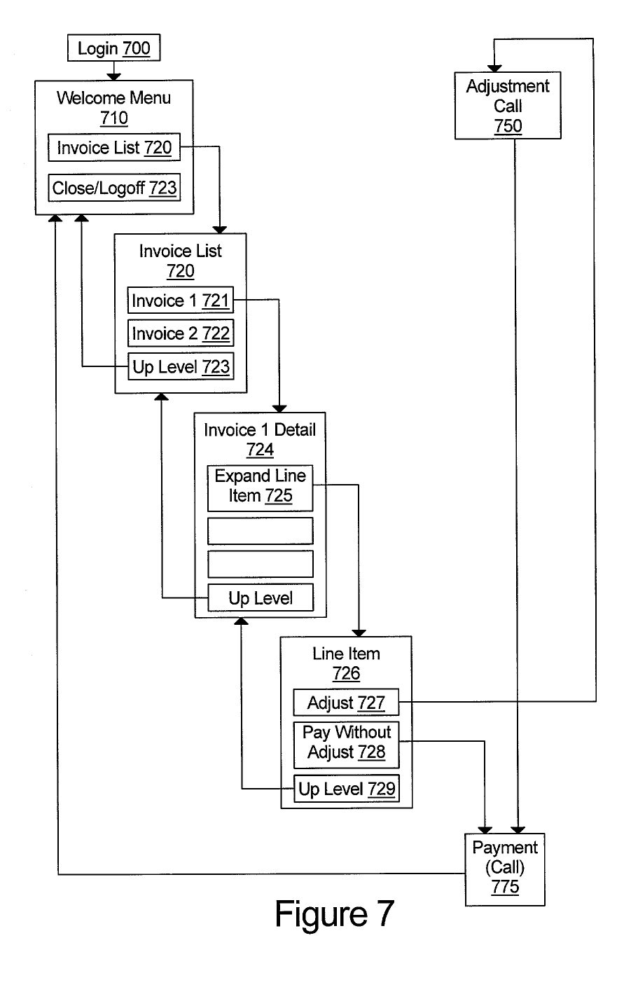

Reference is now made FIG. 7, which is a state diagram showing how the payer user may navigate through various display screens. Once the payer user logs in (700) he (or it) is presented with a welcome menu, as the web server executes code representing a hierarchy of work flow menus that are presented to the operator (user) of the biller system through the open session. The web server transitions between states in accordance with operator selections of menu items as detected through the open session. Note that the payer system user is first presented with welcome menu 710, which contains on it invoice list 720. As the user selects invoice 1 (at 721), he is presented with Invoice 1 detail (at 724), which offers a choice to explode line item (at 725); once the user selects that choice, workflow proceeds and he is presented with a Line Item Workflow Menu (at 726). From the Line Item Workflow Menu the user may select line item adjustment (at 727) or payment of the invoice without adjustment (at 728) or “UpLevel” at 729. Should the user select “pay without adjustment” (at 728) then the item is paid, all databases are updated, payments are reconciled and recorded, and control returns to invoice list 720. However, should the user select invoice line item adjustment, (at 727), control passes to an “Adjustment Call” (at 730); before control returns to invoice list 720, the functionality of the “Adjustment Call” must be performed.

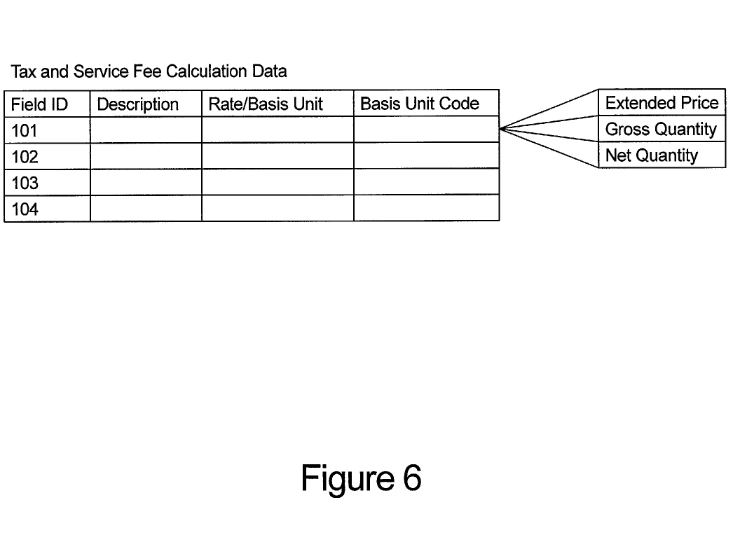

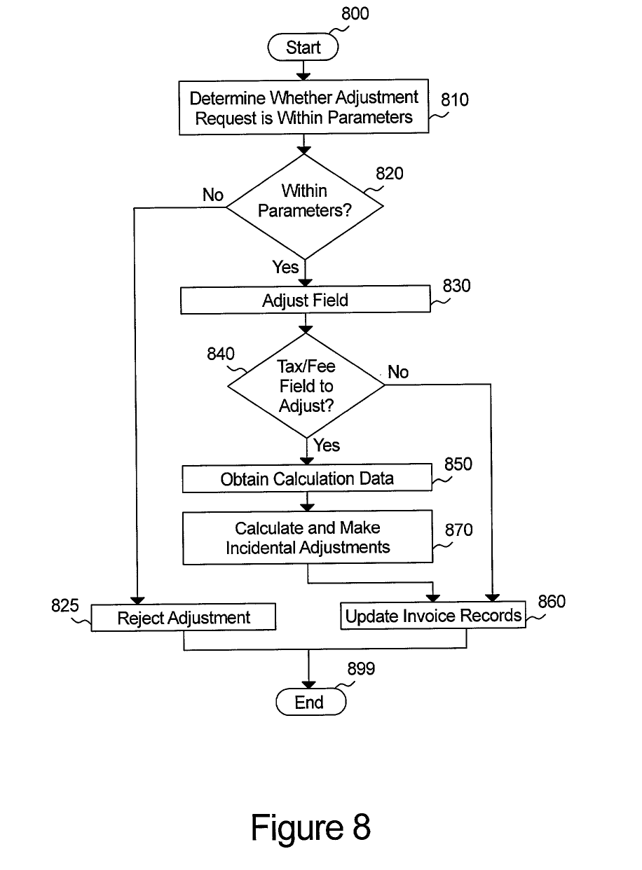

The functionality of “Adjustment Call” 720 is flowcharted in FIG. 8. Referring now to FIG. 8, note that the flowchart starts at 800. An initial check as to whether the adjustment request is within acceptable parameters (stored at adjustment database 26b) is made at branch 820. If the adjustment request is NOT within acceptable parameters, control passes to the “reject adjustment” step at 825, and thence to the end at 899. If the adjustment request IS within acceptable parameters, control passes to the “adjust field” step at 830, and the field is adjusted. Next, a conditional check is performed at step 840, to see whether the previously made adjustment necessitates a separate adjustment of ancillary line items, e.g. tax/fee fields. In making this check, reference is made to tax and service fee database 26c (in FIG. 2) an exemplary structure of which is illustrated at FIG. 6. If the answer to the conditional check is “no”, then no separate adjustment is made, control passes to “update invoice records” at 860, and thence to the end at 899. If, however, the answer to the conditional check is “yes”, then control passes to “obtain calculation data” at 860, and next to “calculate and make incidental (ancillary line) adjustments” at 870, control passes to “update invoice records” at 860, and thence to the end at 899. In all cases, once control has passed to the “Adjustment Call” end at step 899, control then passes (as shown in FIG. 7) to the “Payment Call” step at 775, which effectuates payment in any of a number of ways which are-well known to those of ordinary skill in the relevant arts, and then returns control back to the Welcome Menu (710), which may comprise an invoice list (at 720) and a close/logoff function option (723).

Exemplary pre-defined payer profiles (which may be stored as global information on the database) may comprise the following exemplary types of “gatekeeper” people:

Security Administrator: May have all payer profile and administration permissions, including the ability to set-up and delete ID's, bank accounts and the payer profile itself. The system may not allow this ID to be connected to any billers or any processing permissions. The system may permit this ID access to the security administration report only. The system may permit this ID only to be set-up by the system SuperUser.

Receiving Supervisor: May be provided with a button called “adjust an invoice”. With this new button, the system may permit a receiving administrator to be able to review an invoice and make changes. However, the system may restrict change permissions to quantity adjustments only. The system may link or map this type of ID to an individual biller or group of billers.

Purchasing Manager: May be provided with the buttons for list all invoices; approve invoices (keeping all adjustment capabilities intact); pending payments without the cancel payment privilege; invoice history and biller directories. The system may permit all these permissions to be filtered by biller if the ID were assigned to a particular biller or subset of billers.

Payables Administrator: May have permissions for initiate payments, with one new feature, the ability to create a general invoice adjustment only prior to creating a payment order; pending payments without the cancel payment privilege and payment history. The system may permit all these buttons to be filtered by bank account and biller if the ID were assigned to a particular subset of bank accounts and/or billers. The system may assign this ID the following reports: return items.

Payables Manager: May have permissions for authorize payments; pending payments with cancel payment permissions; payment history; invoice history; payer profile and biller directories. The system may allow this role to be filtered using dollar amount and may assign this ID the following reports: return items.

Controller: May have permissions for list all invoices; pending payments without cancel payment permissions; payment history; and invoice history. The system may assign this ID the following reports: cashflow forecasting; outstanding invoices; discount management; adjusted invoice history and security administrator

Cash Manager: May have permissions for pending payments without cancel payment permissions. The system may assign this ID the following reports: cashflow forecasting report.

Payables Systems Administrator: May be responsible for managing the daily file export routine for both unpaid invoices and payments.

To further understand the advantages of the operation of the present invention, consider now an invoice adjustment for a product such as aviation fuel. A typical invoice adjustment will require at least two individual adjustments to the invoice. The first adjustment to the line item amount associated with the goods or services and a second adjustment to the tax line item(s) associated with the goods or services. However, sometimes more than two adjustments are required, such as when multiple taxing jurisdictions are involved, or when there is a variable rate “tax table” involved, or when flat fee surcharges are involved, e.g. in the course of the sale of some products such as, for example, aviation fuel. Aviation fuel is most commonly sold from a mobile truck at multiple locations, e.g. various points on the tarmac adjacent the aircraft to be fueled. In an instance such as this, a truck full of aviation fuel may leave its depot and proceed to a plurality of aircraft, dispensing all or only some of its contents to the aircraft. Regardless of the amount dispensed, or of the price per unit quantity, however, there will be a flat delivery fee associated with the driving the fuel truck out to each aircraft for fueling. Of course, there is also the base charge per gallon of aviation fuel—a charge which itself may vary day to day according to spot price, quantity dispensed, aggregate quantity purchased by the aircraft operator, etc. and there are Federal, State, and local taxes which vary according to where the plane is refueled—a locality which in some instances may differ from where the refueling truck was filled. It should be clear to the reader that the “Grand Total” on an invoice for aviation fuel is the sum of many terms, that the computation of net amounts due incident to refueling operations are not easy. And truly complex is the computational work necessitated when an aviation fuel purchaser disputes an invoice; and recalculations for the entire disputed invoice must be done, and the results reconciled so as to ensure proper billing and compliance with tax laws and various governmental regulations.

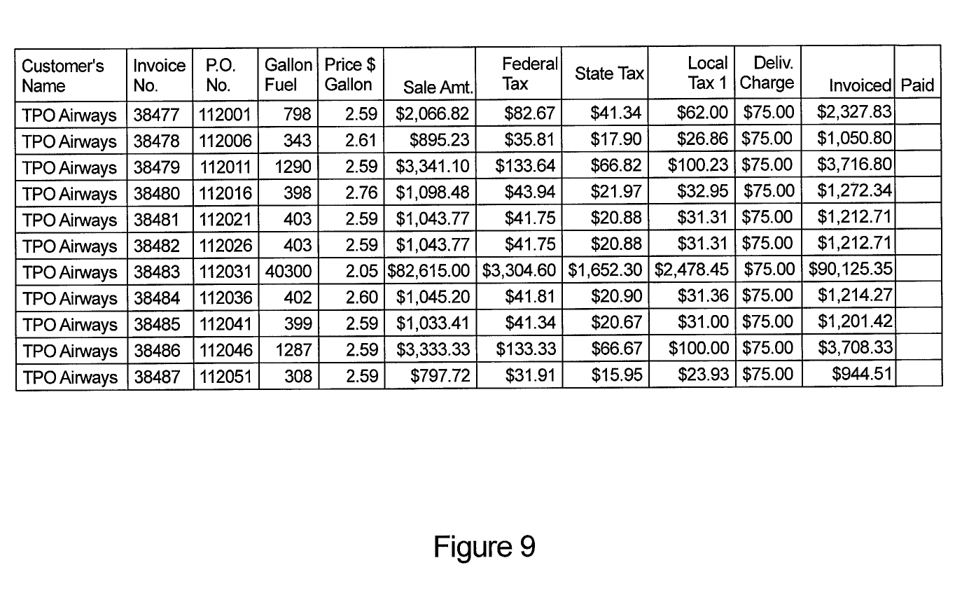

Reference is now made to FIG. 9. As will be made clear from the discussion herein, this invoice bears an error which will require its adjustment utilizing the method and system of the present invention. This invoice governs a number of fuel sales to an executive jet charter company called “Timpoh Airways”. Note that Timpoh Airways purchase relatively modest amounts of fuel—with the striking aberration of one gigantic purchase of 40,300 gallons, as shown in FIG. 9).

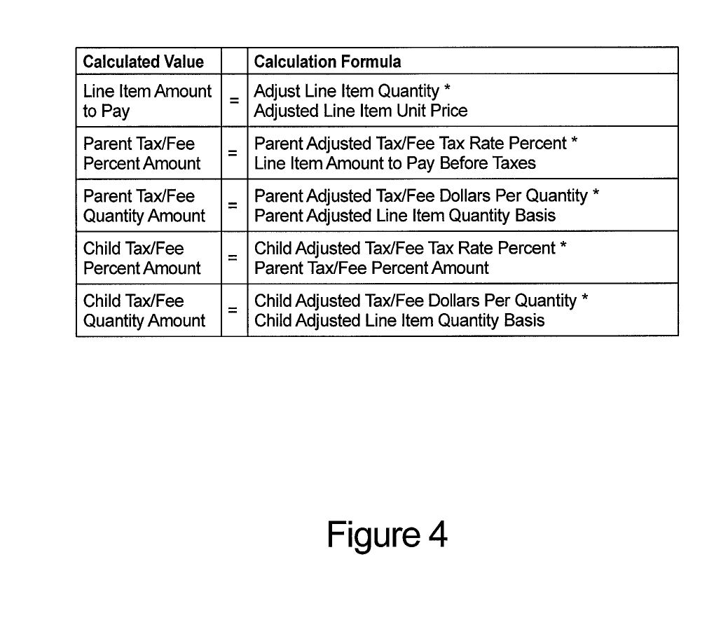

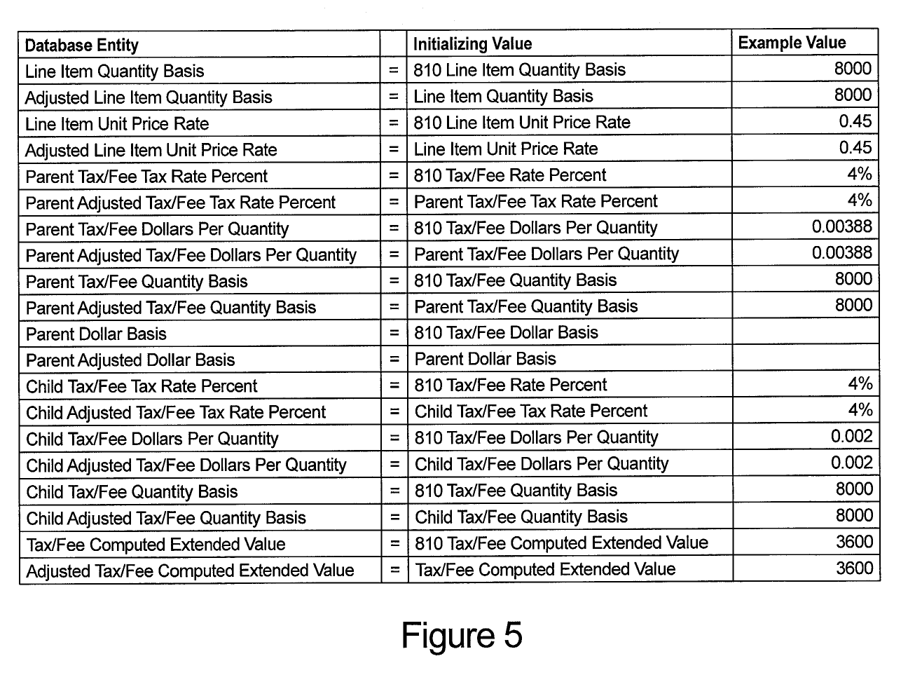

In the Example of FIG. 9, an error has been made—a purchase of 403 gallons has had two zeros added to it, and so appears as 40300 gallons. This error is detected by the payer user, whether manual or automatic, and may involve consideration of data stored in DATABASE 26, or elsewhere. The customer will need to correct this “line item” error by adjusting the invoice, and the system of the present invention will automatically adjust the ancillary charges associated with the line item. This procedure, and indeed the entirety of what is disclosed herein, may be better understood with reference to FIGS. 4 & 5′ and the exemplary formulae and calculations depicted therein.

For exemplary purposes, it may be assumed that no executive jet has a fuel capacity greater than 1500 gallons, and the system may be configured with its adjustment rules (at 266) to reflect this, so as to automatically allow a customer to adjust any gallon amount greater than 2,000 gallons to 2, a lower amount, without the need for further permissions. Thus, the 40300 gallons invoiced in FIG. 9 may readily be adjusted to 403 gallons in accordance with the present invention, as discussed herein.

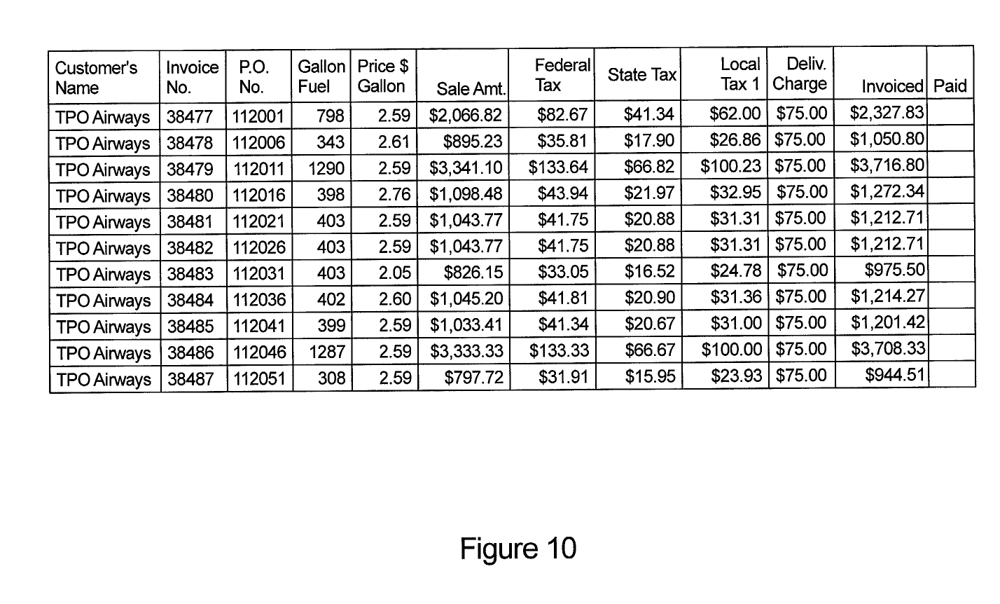

The adjusted invoice is depicted in FIG. 10.

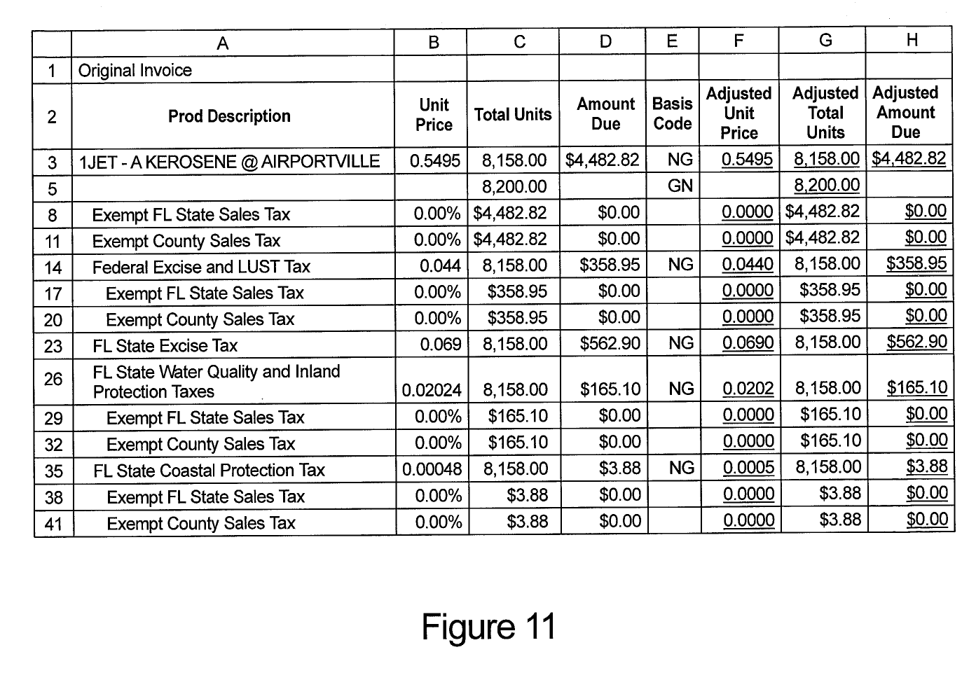

To augment the foregoing, further understanding may be gained by reference to FIGS. 11-15. Referring now to FIG. 11, which, for illustrative purposes, depicts an “Original Invoice” for the sale of Kerosene Jet Fuel (at spreadsheet cell A3; this and similar subsequent references are understood to be references to specific cells on the spreadsheet) in the City of Airportville, State of Florida, and the Country of the United States of America.

As will be made clear herein, each row (a.k.a. line) in the spreadsheet details a cost associated with the purchase and sale of the Jet Fuel. Row 3 identifies the Jet Fuel (A3) and gives the [original, unadjusted] Unit Price (B3) as $0.5495 per unit (Gallon, although any measure might be used); it also gives (C3) the Total Units dispensed as 8, 158.00 [Gallons], the [original, unadjusted, originally invoiced] amount due (at D3) as $4,482.82. Note further that Row 3 gives (at E3) the Basis Code” as “NG”, which stands for “Net Gallons” This means that the line value here—the sale price—is based on “Net Gallons”.

Note that cell F3 gives the Adjusted Unit Price as $0.5495 per unit. As FIG. 11 depicts an unadjusted invoice, this amount is identical to the [Unadjusted] Unit Price given at (B3). For the same reasons, the Adjusted Units given at G3 and the Adjusted Amount Due 2 given at H3 are, respectively, equal to the [unadjusted] Total Units given at C3 and the [Unadjusted] Amount Due given at D3.

FIG. 11, Row 8 gives the Exempt FL State Sales Tax. This tax (like the Exempt County Sales Tax of the following row, row 11) is based on the dollar value of the line item sold. Unit Price (B8) is expressed as a percentage (here, 0.00%). Note also that its “Total Units” (C8) and “Amount Due” (D8) are equal to the values of “Adjusted Total Units” (G8) and “Adjusted Amount Due” (H8), respectively, since, in this FIG. 11, no adjustments are being made.

The Exempt County Sales Tax of the following row, row 11, is computed in like fashion as the Exempt FL State Sales Tax of Row 82 and for brevity need not be discussed further here.

Row 14 sets forth values relating to the so-called “Federal Excise and Leaking Underground Storage Tank (LUST) Tax” It is important to note that the term “tax” here is a misnomer, as the value associated with this row, is a fee, not a tax, since it is based on the quantity sold (Net Gallons (NG) (E14), not on the value of what was sold. Here, the Federal Excise and LUST tax is expressed decimally, as 0.044 (B14), and “Total Units” are equal to the number of units sold, i.e. 8,158.00 [Gallons]. Thus, the [unadjusted] amount due is equal to the product of the previous two values, which is $358.95 (D14). (Again, since FIG. 11 is an original [unadjusted] invoice, its “adjusted” values will all be equal to the “unadjusted” values, and so they will not be discussed further, for reasons of Brevity).

Row 17 sets forth the “Exempt FL State Sales Tax”. Note that this tax is calculated neither on unit quantity sold, nor on the value sold; it is calculated based on the amount due for Federal Excise and Lust Tax (D14), which, in this example is $358.95. Because of this, the “Exempt FL State Sales Tax” (D17) is referred to as the “child” of the Federal Excise and LUST tax (D14), which in turn is referred to as the “parent” of the “Exempt FL State Sales Tax” (D17).

Similarly, Row 20, which sots forth the “Exempt County Sales Tax” (D20) is also calculated on the amount due for Federal Excise and Lust Tax (C17), which, as mentioned in the preceding paragraph, in this example is $358.95. Because of this, the “Exempt FL State Sales Tax” (D20) is also referred to as the “child” of the Federal Excise and LUST tax (D14)), which in turn is referred to as the “parent” of the “Exempt County Sales Tax” (D20).

Continuing down the spreadsheet of FIG. 11, one encounters, at Row 26 the “FL State Water Quality and Inland Protection Taxes” and one also encounters, at row 35, the “FL State Coastal Protection Tax”; as the values of these and their respective “children” are computed in a manner similar to the Federal Excise and LUST tax, discussed above, for reasons of brevity and clarity they need not be discussed further here.

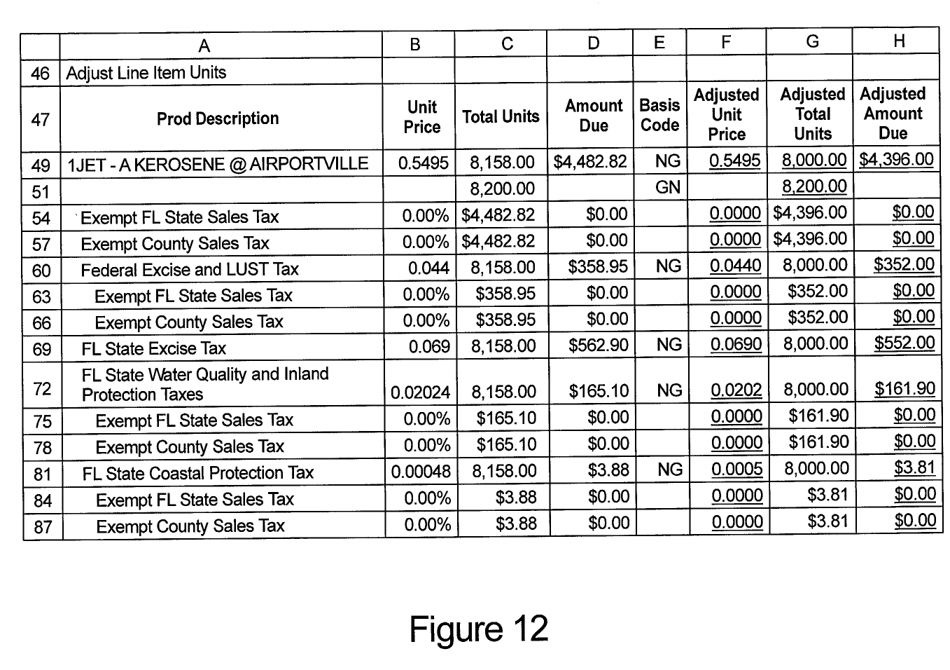

Reference is now made to FIG. 12, which is the spreadsheet of FIG. 11 but with adjustments made in “Total [Line item] Units”. Review of the figures in this spreadsheet will observe how, in accordance with the method and operation of the present invention, a change in one value may be propagated to made corrections in values which depend both directly and indirectly therefrom.

In this regard, note that in FIG. 12 the “Total Units” of jet fuel, originally given as 8,158 [gallons] (C49) (C3 (FIG. 11)), have, in FIG. 12 been adjusted to 8,000 Gallons (G49). Note that, as an immediate effect therefrom, the “Adjusted Amount Due 2” is recalculated to be $4,396.00.

The Adjustment in Total Units (G49) has occasioned a change in the basis upon which the Exempt FL State Sales Tax is based. That basis has changed form its original value (given at C54) of $4,482.82 to its adjusted value (given at G54) of $4,396.00.

Similarly, the Federal Excise and LUST Tax, originally $358.95 (C60) has been recalculated (adjusted) to be $352.00 (H60). That adjusted Federal Excise and LUST Tax value of $352.00 (H60) becomes the new basis for the adjustment of the “child” “Exempt FL State Sales Tax” (A63); the new basis is listed here under “Adjusted Total Units” (G63). This in turn would lead to an adjustment in the value of the “Adjusted amount Due 2” from its unadjusted value of $0.00 (D63) to its new adjusted value, $0.00 (H63). (As those skilled in the relevant arts will recognize, the adjustment in the basis will lead to an adjustment of “Adjusted Amount Due 2”; that adjustment is not readily noticeable in this example because the Unit Price (B63) in this example is given as 0.00%, and multiplying either the adjusted or unattested amounts by 0.00% yields $0.00).

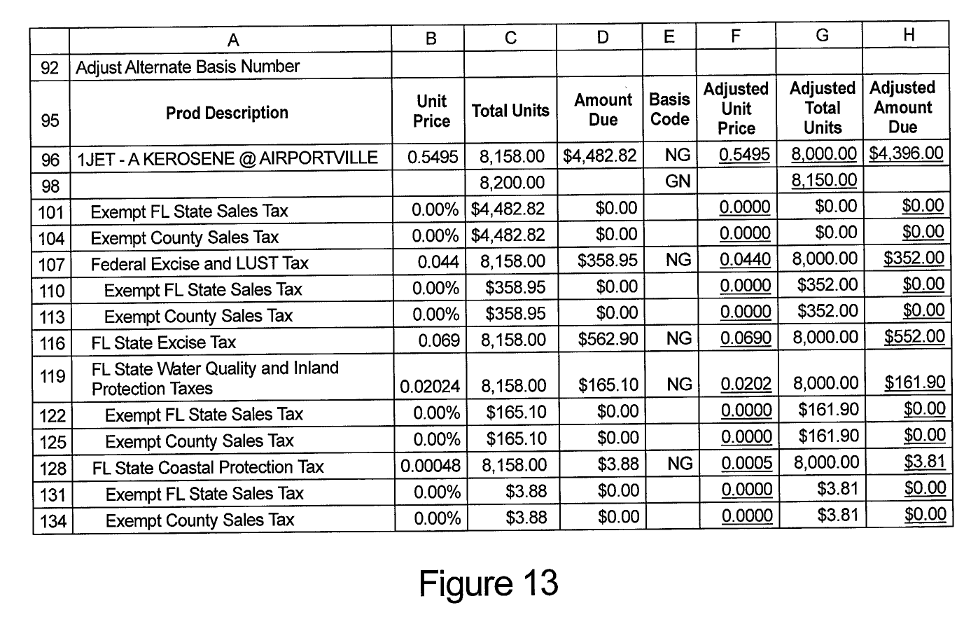

Reference is now made to FIG. 13, a spreadsheet depicting the adjustment of an alternate basis number, associated with the Basis Code “GN” (E98), which stands for “Gross Gallons” [In some situations, “Gross Gallons” may refer to the amount of fuel put on a fuel truck which is driven out to fuel an aircraft' and in these or other situations “Net Gallons” may refer to the amount of fuel which is ultimately actually pun into the aircraft”). Note that the unadjusted “Alternate Basis Number” is “8,200.00” (C98) and that it is adjusted to “8,150.00” (G98) Note also that, in this figure, the “Adjusted Total Units” value for Exempt FL State Sales Tax (G101) has been given as “0.00”.

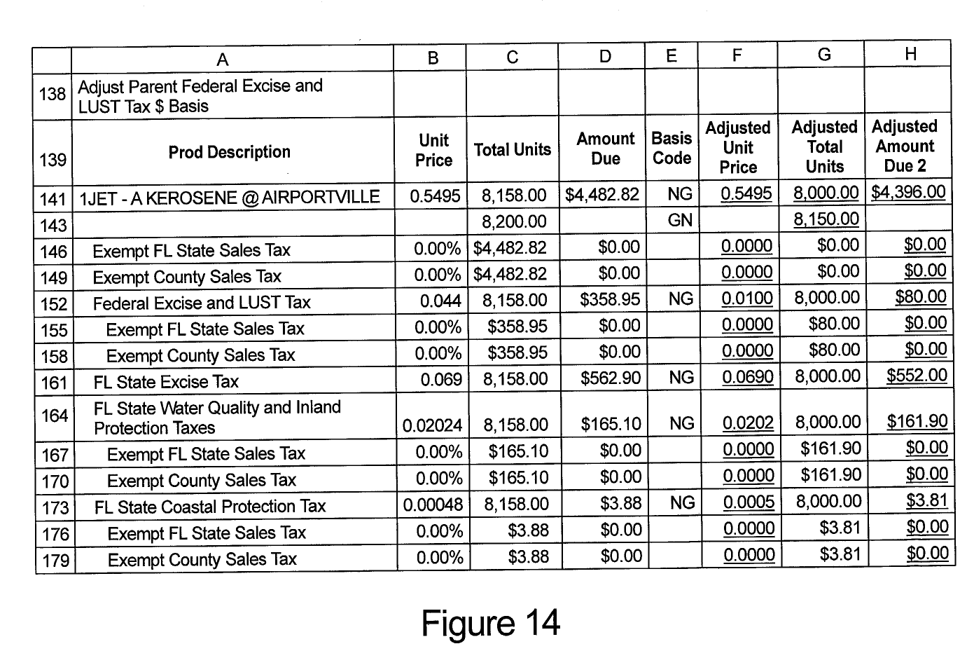

Reference is now made to FIG. 14, which is a spreadsheet depicting the adjustment of the parent Federal Excise and LUST tax. Note that the unadjusted value of Federal Excise and LUST tax was 0.044 (B151) and that this is adjusted to an adjusted value of Federal Excise and LUST tax of 0.0100 (F151). This change is carried through in the calculations as follows: The original Federal Excise and LUST tax had been $358.95 (D151), calculated by multiplying the unadjusted total units of 8158 (C151) by the unadjusted value of Federal Excise and LUST tax of 0.044 (B151). The adjusted value of Federal Excise and LUST tax is $80.00 (H151), calculated by multiplying the previously adjusted (See FIG. 12, above) total units of 8000 (G151) by the now newly-adjusted Federal Excise and LUST tax of 0.0100 (F151). Note further that this adjusted value of $80.00 becomes the adjusted basis of the Exempt County Sales Tax (G158) and also becomes the adjusted basis of the Exempt FL State Sales Tax (G158). Thus, these two “children” each are automatically adjusted when the “parent” Federal Excise and LUST tax is adjusted.

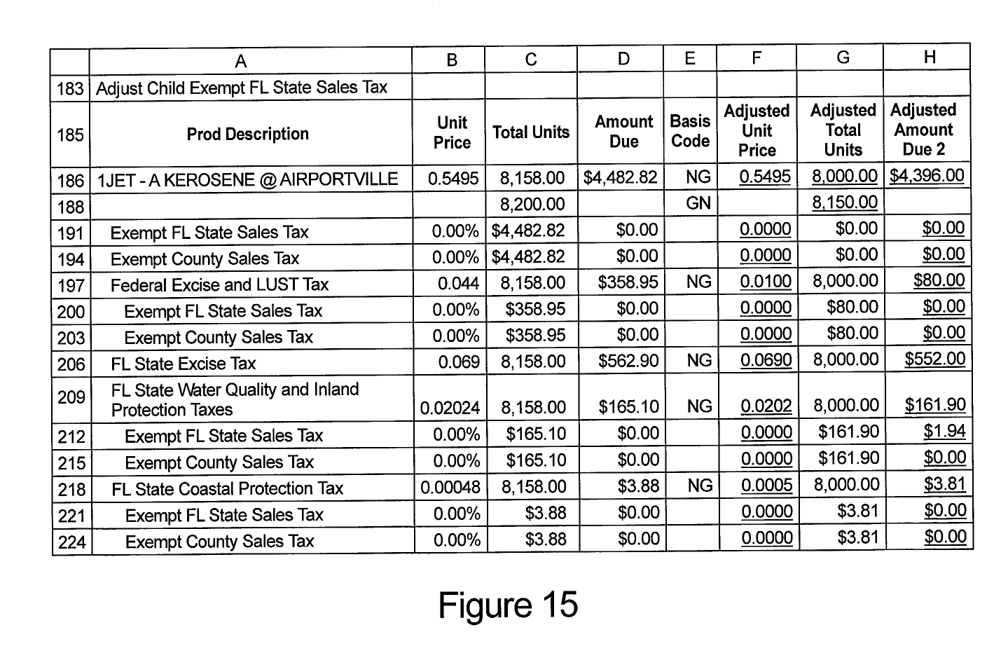

Reference is now made to FIG. 15, a spreadsheet depicting the adjustment of the Child Exempt FL State Sales tax. Note that the unadjusted value of Child Exempt FL State Sales tax was 0.00% (B212) and that this is adjusted to an adjusted value of Child Exempt FL State Sales tax of 0.0120 (F212). This change is carried through in the calculations as follows: The original (unadjusted) Exempt FL State Sales tax had been $0.00 (D212), calculated by multiplying the unadjusted total units of $165.10 (C212) by the unadjusted value Child Exempt FL State Sales tax of 0.00% (B212). The adjusted value of Child Exempt FL State Sales tax is $1.94 (H212), calculated by multiplying the previously adjusted (See FIG. 12, above) total units of $161.90 (G212) by the now newly-adjusted Child Exempt FL State Sales tax of 0.0120 (F212).

Previous examples have focused on two types of fees, namely (1) “Percentage tax/fees”, where the tax/fee Unit Price is a percentage of the basis (e.g. 4.5% of the basis), and (2) Rate tax/fees where the tax/fee Unit Price is a rate per unit of the basis (e.g. $0.025 per unit of the basis). To (1) and (2) is now added a discussion of another type of charge, i.e. (3) “flat fees”. The Unit Price of a flat fee is neither a percentage nor a rate, but a fixed dollar amount.

Flat Fees have a number of characteristics/rules that they obey. These comprise the following: (i) Flat fees will always be direct children of the line item, i.e. a flat fee will never be a child of another tax or fee, nor of another flat fee. A flat fee can however have its own child taxes or fees. (ii) A flat fee will always have a basis. Like the other types of tax/fees, the basis of a flat fee is identified by a basis code (usually GN or NG). (iii) the “Total Units” of a flat fee is always either 1, 0, or −1. This quantity is not adjustable. (iv) The “Unit Price” of the flat fee is a dollar amount. This is adjustable. (v) The so-called “extension” (“Amount Due”) of the flat fee is equal to either the amount, the negative of the amount, or zero, i.e. if the flat fee amount is $40, the extension will either be $40, −$40, or $0. The extension is calculated from the amount and quantity, and is not adjustable.

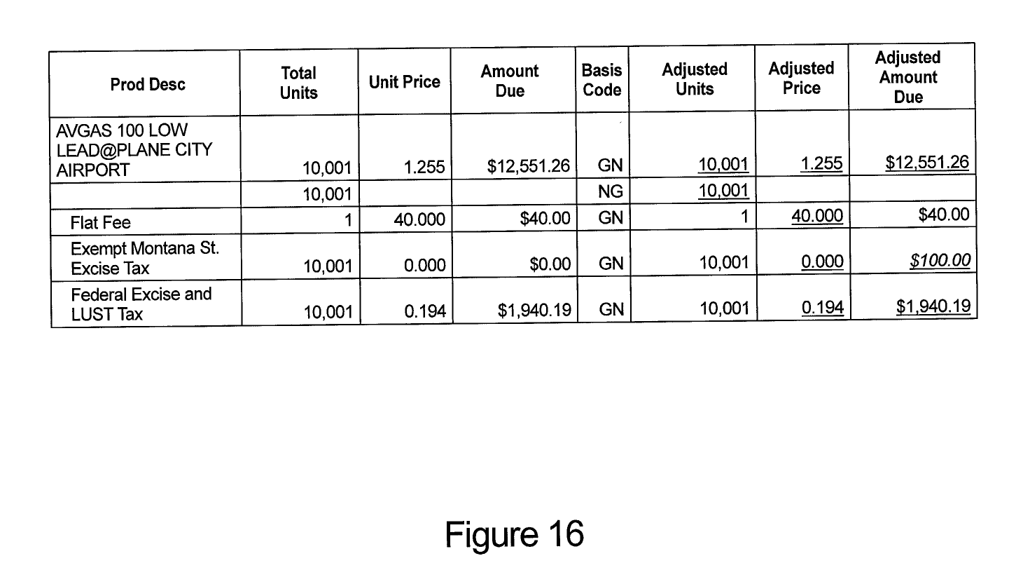

For the User of PAYER SYSTEM 14 Flat fees will appear in the line item detail in the same way as normal tax/fee items. The only difference will be that since neither the Amount nor the extension will be adjustable, neither will have links. An example illustrating this is given in FIG. 16, in which each link is identified by an underlining. For the user of BILLER SYSTEM 12, the biller view will be similar to the payer view, except that the Adjusted Price column will only be a link if the payer actually adjusted the flat fee, and in that case will be a link to read-only information about the adjustment.

As suggested above, a flat fee may be affected by certain adjustments. The table below shows the behavior of a flat fee when its parent line item is adjusted.

| Action on Parent Line Item | |
|---|---|
| Basis Quantity | Effect on Child Flat Fee |
| Initially positive, adjusted to | No effect |
| another positive value | |
| Initially positive, adjusted to zero | Adjusted units is recalculated to zero, and thus |
| | flat fee extension is recalculated to zero |
| Initially positive, adjusted to a | Sign of flat fee adjusted units is flipped. If it |
| negative value | was −1, it becomes +1; if it was +1, it |
| | becomes −1. Extension of flat fee also flips |
| | sign. |
| Initially negative, adjusted to | No effect |
| another negative value | |
| Initially negative, adjusted to zero | Amount is recalculated to zero, and thus flat |
| | fee extension is recalculated to zero |
| Initially negative, adjusted to a | Sign of flat fee adjusted units is flipped. If it |
| positive value | was −1, it becomes +1; if it was +1, it |
| | becomes −1. Extension of flat fee also flips |
| | sign. |

A list of characteristics or rules respecting flat fees further comprises the following: (i) Adjustments to a parent line item's extension (Line Item Amount Due) or unit price will have no effect on the flat fee. (ii) In the trivial case that the flat fee Total Units comes in as 0, the Adjusted Units remains zero always (is not recalculated), and the flat fee extension also remains zero. (iii) Only the Unit Price of the flat fee itself is adjustable; when this is adjusted, the extension is recalculated, and any child taxes and fees attached to the flat fee will be recalculated in the usual manner.

In one embodiment, source code may be written in an object-oriented programming language using relational databases. Such an embodiment may include the use of programming languages such as C++. Other programming languages which may be used in constructing a system according to the present invention include Java, HTML, PERL, UNIX shell scripting, assembly language, FORTRAN, Pascal, Visual Basic, and QuickBasic. Those skilled in the art will recognize that the present invention may be implemented in hardware, software, or a combination of hardware and software. Moreover, while examples herein make frequent reference to products, this is by way of example only, it being readily understood by those skilled in the relevant arts that services may be substituted for products herein.

It should also be appreciated from the outset that one or more of the functional components may alternatively be constructed out of custom, dedicated electronic hardware and/or software, without departing from the present invention. Thus, the present invention is intended to cover all such alternatives, modifications, and equivalents as may be included within the spirit and broad scope of the invention as defined only by the hereinafter appended claims.

What is claimed is:

1. An electronic bill presentment and payment system for presenting a product sales invoice of a vendor to a customer, the system comprising:
a) a billing database comprising means for storing an invoice file, said invoice file comprising a first product price line value, said product line value representing an amount payable by the customer for a taxable product provided by the vendor and said invoice file further comprising a tax line value representing an tax amount payable by the customer as a tax on said taxable product;
b) an application server for:
i) receiving from said customer a request to adjust the line value;
ii) Providing, in response to said line value, instructions to replace the line value with an adjusted line value;
iii) calculating, for each adjusted line value, an adjusted tax value based on the adjusted line value; and
iv) providing instructions to replace the tax value with the adjusted tax value.

2. The electronic bill presentment and payment system of claim 1, wherein the application server further provides MEANS for notifying the vendor of the adjusted line value and the adjusted tax value.

3. The electronic bill presentment and payment system of claim 1, wherein said billing database further comprises means for storing invoice records, means for storing adjustment rules, means for storing staring Tax & Service Fee Data, means for storing Biller Profiles, means for storing Payer Profiles, means for storing Business Service Provider Profiles, means for storing Accounting Systems Interface Application (ASIA) profiles.

4. The electronic bill presentment and payment system of claim 3, wherein the invoice file further comprises a fee line value representing an amount payable by the customer as a fee on the product, and the application server further provides for:
v) calculating, for each fee line value, an adjusted fee line value based on the adjusted line value, and
vi) providing instructions to replace the fee line value with the adjusted fee line value.

5. The electronic bill presentment and payment system of claim 4, wherein the application server further provides for notifying the vendor of the adjusted line value, the adjusted tax line value, and the adjusted fee line value.

6. The electronic bill presentment and payment system of claim 5, wherein the invoice file further comprises a second product price line value representing an amount payable by the customer for said second product provided by the vendor, the tax line value represents an amount payable by the customer as a tax on both said first product and on said second product, and the fee value represents an amount payable by the customer as a fee on both said first product and on said second product.

6. An electronic bill presentment and payment system for presenting a product sales invoice of a vendor to a customer, the system comprising:
a) a billing database comprising means for storing an invoice file, said invoice file comprising a first product price line value, said product line value representing an amount payable by the customer for a taxable product provided by the vendor and said invoice file further comprising a tax line value representing an tax amount payable by the customer as a tax on said taxable product
b) an adjustment file comprising adjustment parameters established by the vendor; and
c) an application server for (i) receiving a request to adjust a product price line value from the customer, (ii) evaluating whether the request to adjust the line item is within the adjustment parameters, whereby, if the request to adjust the product price line item is within said adjustment parameters, said application server
i) provides instructions to replace the product price line value with an adjusted product price line value, and (ii) calculates an adjusted tax line value based on the adjusted tax line value, and (iii) provides instructions to replace said tax line value with said adjusted tax line value.

7. The electronic bill presentment and payment system of claim 6, wherein the application server further provides for notifying the vendor of the adjusted line value and the adjusted tax value.

8. The electronic bill presentment and payment system of claim 6, wherein the invoice file further comprises a fee line value representing an amount payable by the customer as a fee on the product, and the application server further provides for:
v) calculating, for each fee line value, an adjusted fee line value based on the adjusted line value, and
vi) providing instructions to replace the fee line value with the adjusted fee line value

9. The electronic bill presentment and payment system of claim 8, wherein the application server further provides for notifying the vendor of the adjusted line value and the adjusted tax value.

10. The electronic bill presentment and payment system of claim 9, wherein the invoice file further comprises a second product price line value representing an amount payable by the customer for said second product provided by the vendor, the tax line value represents an amount payable by the customer as a tax on both said first product and on said second product, and the fee value represents an amount payable by the customer as a fee on both said first product and on said second product.

11. An electronic bill presentment and payment system for presenting a product sales invoice of a vendor to a customer, the system comprising:
a) a billing database comprising means for storing an invoice file, said invoice file comprising a first product price line value, said product line value representing an amount payable by the customer for a taxable product provided by the vendor and said invoice file further comprising a first tax line value representing an tax amount payable by the customer as a tax based on the price of said taxable product;, and said invoice file still further comprising a second tax line value representing a second tax amount payable by the customer as a tax based on the amount of said first tax line value;
b) an application server for:
i) receiving from said customer a request to adjust said product line value;
ii) providing, in response to said request to adjust said product line value, instructions to replace said product line value with an adjusted product line value;
iii) calculating, for each adjusted product line value, an adjusted first tax line value based on the adjusted product line value; and
iv) providing instructions to replace the first tax line value with said adjusted first tax line value;
v) calculating, for said adjusted first tax line value, a second adjusted tax line value based on said adjusted first tax line value; and
vi) providing instructions to replace said second tax line value with said second adjusted tax line value.

12 The electronic bill presentment and payment system of claim 11, wherein the application server further provides MEANS for notifying the vendor of the adjusted line value and the adjusted tax value.

13 The electronic bill presentment and payment system of claim 11, wherein said billing database further comprises means for storing invoice records, means for storing adjustment rules, means for storing Tax & Service Fee Data, means for storing Biller Profiles, means for storing Payer Profiles, means for storing Business Service Provider Profiles, means for storing Accounting Systems Interface Application (ASIA) profiles.

14. The electronic bill presentment and payment system of claim 13, wherein the invoice file further comprises a fee line value representing an amount payable by the customer as a fee on the product, and the application server further provides for:
v) calculating, for each fee line value, an adjusted fee line value based on the adjusted line value, and
vi) providing instructions to replace the fee line value with the adjusted fee line value.

15. The electronic bill presentment and payment system of claim 14, wherein the application server further provides for notifying the vendor of the adjusted line value, the adjusted tax line value, and the adjusted fee line value.

16. The electronic bill presentment and payment system of claim 15, wherein the invoice file further comprises a second product price line value representing an amount payable by the customer for said second product provided by the vendor, the tax line value represents an amount payable by the customer as a tax on both said first product and on said second product, and the fee value represents an amount payable by the customer as a fee on both said first product and on said second product.
